(19) United States
(12) Patent Application Publication
(10) Pub. No.: US 2024/0108978 A1
(43) Pub. Date: Apr. 4, 2024

(54) REMOTE DISPLAY SYNCHRONIZATION TO PRESERVE LOCAL DISPLAY

(71) Applicants: ADVANCED MICRO DEVICES, INC., SANTA CLARA, CA (US); ATI TECHNOLOGIES ULC, MARKHAM (CA)

(72) Inventors: Jeffrey G. Cheng, Markham (CA); Yuping Shen, Orlando, FL (US); Mikhail Mironov, Markham (CA); Min Zhang, Markham (CA)

(21) Appl. No.: 17/955,651

(22) Filed: Sep. 29, 2022

(51) Int. Cl. A63F 13/355; A63F 13/358; H04N 19/132

(52) U.S. Cl. CPC A63F 13/355; A63F 13/358; H04N 19/132

(57) ABSTRACT

A remote display synchronization technique preserves the presence of a local display device for a remotely-rendered video stream. A server and a client device cooperate to dynamically determine a target frame rate for a stream of rendered frames suitable for the current capacities of the server and the client device and networking conditions. The server generates from this target frame rate a synchronization signal that serves as timing control for the rendering process. The client device may provide feedback to instigate a change in the target frame rate, and thus a corresponding change in the synchronization signal. In this approach, the rendering frame rate and the encoding frequency may be “synchronized” in a manner consistent with the capacities of the server, the network, and the client device, resulting in generation, encoding, transmission, decoding, and presentation of a stream of frames that mitigates missed encoding of frames while providing acceptable latency.

### BACKGROUND

Remote, or “cloud-based,” video gaming systems employ a remote server to receive user gaming input from a client device via a network, execute an instance of a video game based on this user gaming input, and deliver a stream of rendered video frames and a corresponding audio stream over the network to the client device for presentation at a display and speakers, respectively, of the client device. Typically, for the video content the server employs a render-and-capture process in which the server renders a stream of video frames from the video game application and an encoder encodes the pixel content of the stream of video frames into an encoded stream of video frames that is concurrently transmitted to the client device. Typically, the render process and the capture process are decoupled. The server implements a streaming pipeline process in which the server executes the video game and renders frames and in parallel executes another application to capture and encode the rendered frames. The separation of frame rendering and capture and encoding causes the encoding frequency to be inconsistent with the rendering frame rate, which typically leads to the encoder “missing” frames (that is, not encoding frames for inclusion in the transmitted encoded stream) as well as leading to relatively high and inconsistent latency across the stream of frames. Thus, if the rendering frame rate is maintained at a frame rate that is lower than the encoding frequency, this can reduce latency and avoid missed frames, but may result in a lower display frame rate at the client device than otherwise would be available. Conversely, if the encoding frequency is less than the rendering frame rate, rendered frames are “missed” by the encoder as it works to catch up with the rendering process, which leads to the aforementioned high and inconsistent latency, while also wasting power in the generation of the rendered frames that are missed and thus ultimately not presented at the client device. Moreover, the separation of the server frame rendering and encoding rates, and the client decoding and display rates, also leads to greater latency and/or missed frames.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a server-based video gaming system in accordance with some implementations.

FIG. 2 is a block diagram illustrating a hardware configuration of a client device of the video gaming system of FIG. 1 in accordance with some implementations.

FIG. 3 is a block diagram illustrating a hardware configuration of a gaming server of the video gaming system of FIG. 1 in accordance with some implementations.

FIG. 4 is a flow diagram illustrating a method for remote frame rate synchronization between a server and a client device of a server-based video gaming system in accordance with some implementations.

FIG. 5 is a flow diagram illustrating a method for render rate control for remote frame rate synchronization based on selective present call blocking in accordance with some implementations.

### DETAILED DESCRIPTION

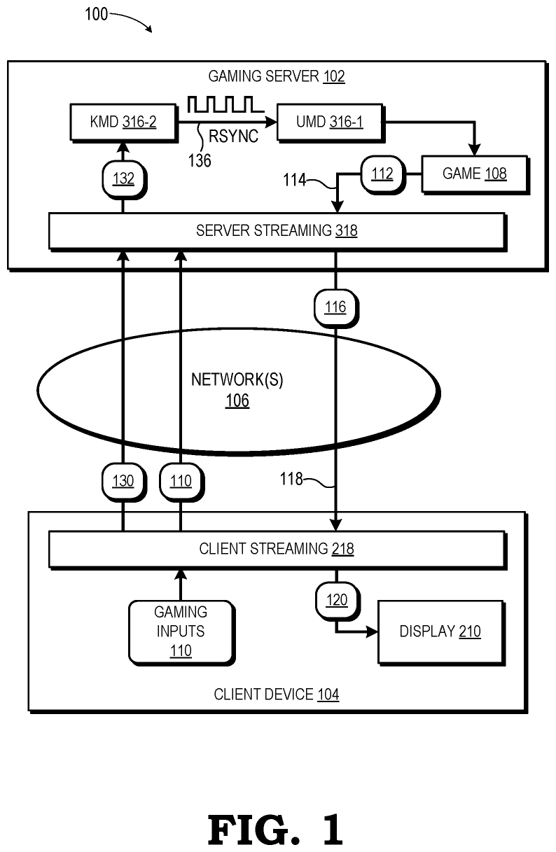

The pixel-streaming approach in remote video gaming systems and other systems that render graphics content remotely for display at a local device rely on a frame rendering process and a frame capture (encoding) process (that is, a “streaming process”) that may have disparate capacities, resulting in relatively high or variable latency (when rendering capacity exceeds encoding capacity) or an artificially-reduced frame rate at the local device (when rendering capacity is maintained below encoding capacity). To mitigate the disparity between such capacities, FIGS. 1-5 illustrate systems and methods for a remote display synchronization technique that preserves the presence of a local display and its characteristics. In at least one implementation, the server and the client device cooperate to determine a target frame rate that is suitable for both the current capacities of the server as well as the current capacities of the client device, as well as the network(s) connecting the two. The server then generates from this target frame rate a series of frame rate synchronization signals (referred to herein as “remote sync” or “RSync”) that serves as timing control for the present cadence for the rendering process as well as for the encoding process. Moreover, on a periodic basis or in response to one or more triggers, the client device may provide update feedback to instigate a change in the target frame rate, and thus a corresponding change in the synchronization signal. In this approach, the rendering frame rate and the encoding frequency may be “synchronized” in a manner that is consistent with the capacities of the server, the network, and the client device, resulting in generation, encoding, transmission, decoding, and presentation of a stream of rendered video frames that mitigates missed encoding of rendered frames while preserving acceptable latency. Further, the server and client device may cooperate to communicate various display characteristics implemented by the executing video game for implementation at the client device. For example, the video game application may execute with vertical synchronization (vsync) either enabled or disabled, and this vsync status may be communicated from the server to the client device for implementation of the indicated vsync status at the client device.

Note that for ease of illustration, the systems and techniques of the present disclosure are described in the example context of a server-based video game system in which an instance of a video game application is executed remotely and its rendered video and audio output encoded and streamed to a client device, whereupon the client device decodes the video and audio content and presents the resulting decoded content to a user. However, these systems and techniques are not limited to a server-based gaming context, but instead may be employed in any of a variety of scenarios in which real-time video content is remotely rendered and the resulting pixel content then remotely encoded for delivery as an encoded video stream to one or more client devices. Thus, reference to “video game” applies equally to such equivalent scenarios unless otherwise indicated.

FIG. 1 illustrates a remote video gaming system 100 for providing server-based video gaming in accordance with some implementations. The system 100 includes a video gaming server 102 (hereinafter, “gaming server 102” for brevity) remotely connected to at least one client device 104 via one or more networks 106. The client device 104 can include, for example, a smartphone, a compute-enabled vehicle entertainment system, a compute-enabled appliance, a tablet computer, a laptop computer, a desktop computer, a video game console, a television, and the like. The one or more networks 106 can include one or more wireless networks, such as a personal area network (PAN, a cellular network, or a wireless local area network (WLAN), one or more wired networks, such as a local area network (LAN) or a wide area network (WAN), the Internet, or combinations thereof.

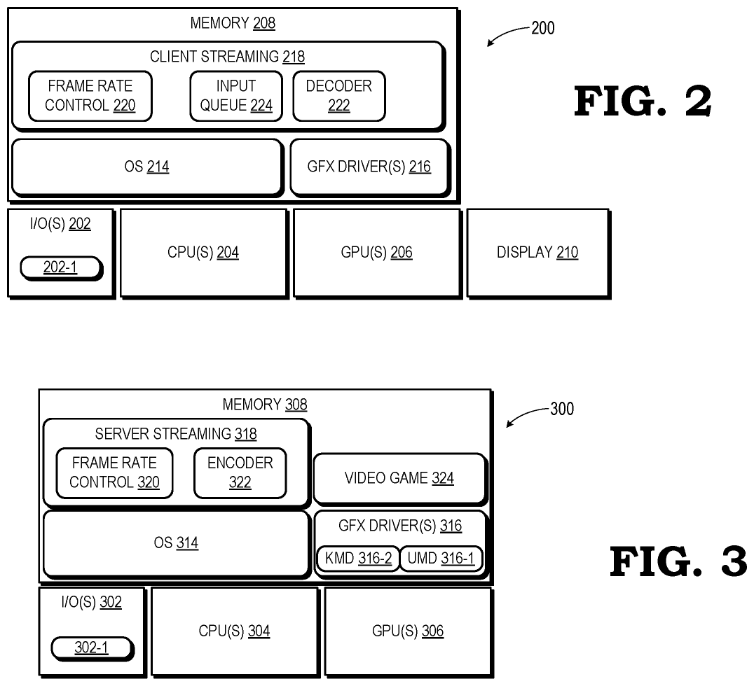

Turning briefly to FIGS. 2 and 3, example hardware configurations for the client device 104 and the gaming server 102, respectively, are illustrated. As shown in FIG. 2, the illustrated hardware configuration 200 for the client device 104 includes one or more I/O devices 202, including a network interface 202-1 for interfacing with the one or more networks 106, one or more central processing units (CPUs) 204, one or more graphics processing units (GPUs) 206, one or more memories 208, as well as a display 210 integrated with or otherwise connected to, the client device 104. Other well-known hardware components typically implemented at a client device, such as speakers, microphones, power supplies, busses, power managers, etc., are omitted for clarity. The one or more memories 208 include one or more types of memory, such as random access memory (RAM), read-only memory (ROM), Flash memory, hard disc drives, register files, and the like, and store one or more sets of executable instructions that, when executed by the one or more CPUs 204 and/or the one or more GPUs 206, manipulate the hardware of the client device 104 to perform the functionality ascribed to the client device 104 herein. In particular, the executable instructions can implement an operating system (OS) 214 for overall control and coordination of the hardware components of the client device 104, a set 216 of graphics (GFX) drivers, such as a user mode driver (UMD) and a kernel mode driver (KMD), for coordination and control of the one or more GPUs 206 by the one or more CPUs 204, and a client streaming application 218. The client streaming application 218 in turn includes a frame rate control module 220 for coordination of a rendering frame rate by the gaming server 102, as described below, as well as a decoder 222 that operates to decode encoded video frames received from the gaming server 102 and buffered in, for example, an input queue 224.

As shown in FIG. 3, the illustrated hardware configuration 300 for the gaming server 102 includes one or more I/O devices 302, including a network interface 302-1 for interfacing with the one or more networks 106, one or more CPUs 304, one or more GPUs 306, and one or more memories 308 (e.g., RAM, ROM, flash memory, hard disc drives, or a combination thereof). Other well-known hardware components typically implemented at gaming server, such as power supplies, busses, power managers, etc., are omitted for clarity. The one or more memories 308 store one or more sets of executable instructions that, when executed by the one or more CPUs 304 and/or the one or more GPUs 306, manipulate the hardware of the gaming server 102 to perform the functionality ascribed to the gaming server 102 herein. In particular, the executable instructions can implement an OS 314 (and hypervisor for a multi-tenancy implementation) for overall control and coordination of the hardware components of the gaming server 102, a set 316 of graphics (GFX) drivers, such as a KMD 316-2 and a UMD 316-1, for coordination and control of the one or more GPUs 306 by the one or more CPUs 304, and a server streaming application 318. The server streaming application 318 in turn includes a frame rate control module 320 for coordination with the frame rate control module 220 of the client device 104 for setting rendering frame rate by the gaming server 102, as described below, as well as an encoder 322 that operates to encode video frames rendered by an executing instance of a video game application 324.

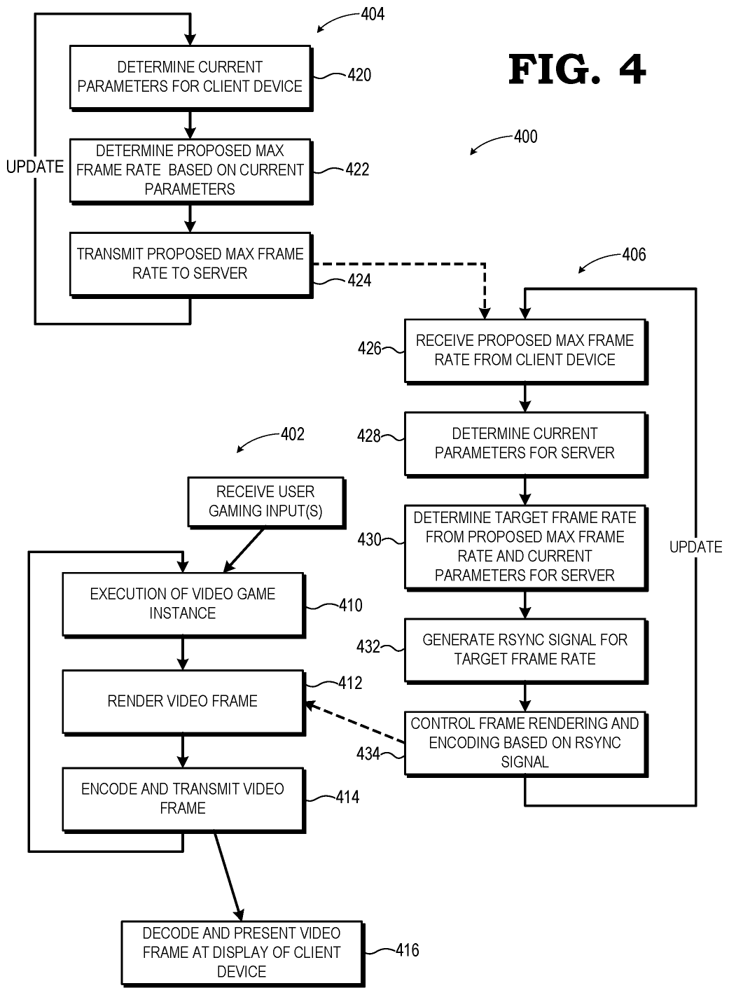

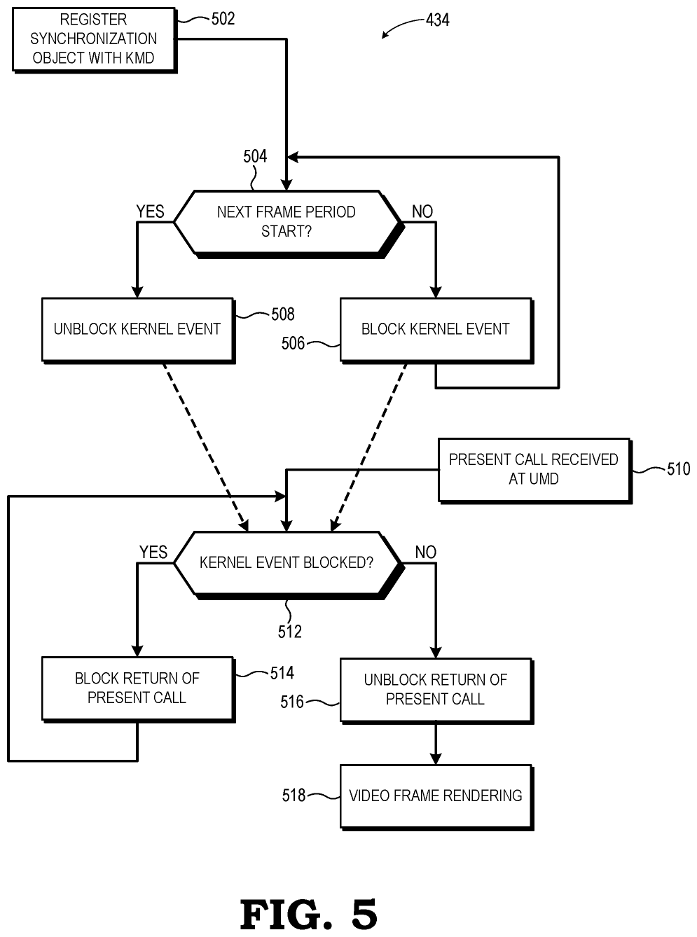

Referring to FIG. 4, a method 400 for remote display synchronization is for the video game system 100 of FIGS. 1-3 is illustrated in accordance with at least one implementation. While the method 400 is described in the example context of the video game system 100 of FIG. 1 and the corresponding hardware configurations of the client device 104 and the gaming server 102 of FIGS. 2 and 3, respectively, the method 400 may be implemented in other scenarios in which video content is rendered remotely and the corresponding pixel content encoded and transmitted in real time using the guidelines provided herein. The illustrated method 400 includes three concurrently-performed subprocesses: a video game streaming subprocess 402 performed by the gaming server 102 and the client device 104 in combination, a client reporting subprocess 404 performed by the client device 104, and a frame rate configuration subprocess 406 performed by the gaming server 102.

Turning first to the video game streaming subprocess 402, at block 410 the gaming server 102 executes an instance 108 (FIG. 1) of the video game application 324 (hereinafter, “video game instance 108”) on behalf of the client device 104. In at least one implementation, the execution of the video game instance 108 is responsive to user gaming inputs 110 (FIG. 1) received at one or more I/O devices 202 of the client device 104, such as a keyboard, mouse, gamepad, game controller, or touchscreen, and transmitted to the gaming server 102 by the client streaming application 218. These user gaming inputs 110 are provided as inputs to the executing video game instance 108, which adjusts the game play in response to the user gaming inputs 110. According to an indicated frame rate (described below), at block 412 the video game instance 108 directs the rendering of a stream 114 of video frames 116 (FIG. 1), each of which represents the visual or graphical content of a current aspect of the executing instance of the video game instance 108 at a corresponding point in time, such as the current state of the game play from a corresponding perspective, a menu screen, and the like. At block 414, the encoder 322 of the server streaming application 318 encodes each rendered video frame 112 to generate an encoded video frame 116 and the server streaming application 318 then transmits the encoded video frame 116 to the client device 104 via the one or more networks 106 as part of a transmitted data stream 118. A stream of audio data (not shown) representing corresponding audio content is also generated by the gaming server 102 and then encoded for inclusion as an encoded audio stream as part of the transmitted data stream 118. This subprocess then repeats for the generation, encoding, and transmission of the next video frame 116 at the indicated frame rate.

For each transmitted encoded video frame 116, at block 416 the client streaming application 218 at the client device 104 receives the data representing the encoded video frame 116 in the data stream 118 and decodes the encoded video frame 116 to generate a decoded video frame 120 (FIG. 1) and provides the decoded video frame 120 to the display 210 associated with the client device 104 for display. Similarly, corresponding encoded audio content is decoded and then provided to one or more speakers for audio output in synchronization with the display of the corresponding rendered video content.

Ideally, the capacity of the gaming server 102 to encode the video frames 112, the capacity of the gaming server 102 to render the video frames 112, the capacity of the network(s) 106 to transmit the encoded video frames 116, and the capacity of the client device 104 to decode and present the decoded video frames 120 for display match or are at least compatible. However, in actual implementation there is a mismatch between these capacities, with a mismatch between the capacity for frame rendering and the capacity for frame encoding at the gaming server 102 often having the largest impact in the form of missed frames for encoding and/or significant and variable latency in the encoding and networking transmission process. Accordingly, in at least one implementation, the client device 104 and the gaming server 102 together implement a remote synchronization process in which a suitable frame rendering rate is determined at the gaming server 102 based on input from the client device 104 and which serves to more suitably balance rendering performance and latency. This remote synchronization process is represented by the subprocesses 404 and 406 of method 400.

Starting with subprocess 404, at block 420 the frame rate control module 220 of the client streaming application 218 determines one or more current parameters of the client device 104 that could impact the rate at which the client device 104 can receive, decode, and display video frames from the transmitted data stream 118. Such parameters can include, for example, the frame rate display range of the display 210, the decoding capacity of the client device 104 (e.g., the hardware and other resources available for decoding), the current power state or current temperature state of the client device 104, the fullness of one or more buffers used to buffer frame date for decoding or for display, as well as the current parameters for the one or more networks 106, such as the current bandwidth and/or latency between the gaming server 102 and the client device 104 provided by the one or more networks 106. At block 422, the frame rate control module 220 uses the current parameters determined at block 420 to determine a proposed maximum frame rate 130 (FIG. 1) that can reasonably be supported by the client device 104 in view of the identified current parameters. The client streaming application 218 can rely on any of a variety of parameters in determining the proposed maximum frame rate 130. For example, the frame rate control module 220 may consider one or more of the frame rate display range of the display 210 and the decoding capacity of the client device 104 (e.g., the hardware and other resources available for decoding), as well as the current parameters for the one or more networks 106, such as the current bandwidth and/or latency between the gaming server 102 and the client device 104 provided by the one or more networks 106. For example, the frame rate control module 220 may monitor the input buffer used to buffer incoming frame data for decoding and may determine the proposed maximum frame rate 130 at least in part from the current buffer fullness (or from the current rate of change in buffer fullness). As another example, the current power state and/or current temperature state (indicating decoding hardware resources current available) may be considered. The frame rate control module 220 may determine the proposed maximum frame rate 130 from these considered parameters using any of a variety of techniques. For example, the frame rate control module 220 may employ a weighted sum equation for these parameters, an algorithm that determines a frame rate from these parameters, a populated look-up table (LUT) that uses some or all of these parameters as inputs, a trained deep neural network (DNN) or other neural network, and the like. At block 424, the client streaming application 218 transmits the determined proposed maximum frame rate 130 to the gaming server 102 via the one or more networks 106. The subprocess 404 then may be repeated for another iteration to update the proposed maximum frame rate 130 based on updated current parameters of the client device 104, wherein the next iteration of the subprocess 404 may be performed on a periodic basis (e.g., in response to a repeating timer), in response to an aperiodic trigger (e.g., a considered parameter changing by more than a threshold amount), and the like.

The subprocess 406 is initiated by the transmission of the proposed maximum frame rate 130 by the client device 104. Accordingly, at block 426 the frame rate control module 320 of the server streaming application 318 receives the proposed maximum frame rate 130, and in response, at block 428 determines one or more current parameters of the gaming server 102 that could impact the ability of the gaming server 102 to render, encode, or transmit video frames from the executing video game instance 108. As such, these parameters can include, for example, network performance parameters (e.g., bandwidth or latency) as observed by the gaming server 102, hardware capabilities of the gaming server 102, frame rate limits or other client-directed policies put in place by an operator of the gaming server 102, server occupancy/utilization (e.g., the number of instances of the video game application 324 or other video game applications being executed for other client devices), and the like. At block 430, the frame rate control module 320 uses the proposed maximum frame rate 130 and the determined server-side current parameters to determine a target frame rate 132 (FIG. 1) that is consistent with the proposed maximum frame rate 130 and the server's current capacity as represented by the determined current server parameters. As with the client-side determination of the proposed maximum frame rate 130, the frame rate control module 320 can determine the target frame rate 132 in any of a variety or combinations of ways, such as using a weighted equation, an algorithm, one or more LUTs, a DNN or other neural network, or a combination thereof. In other implementations, the frame rate control module 320 may select a target frame rate 132 from a set of options. For example, the frame rate control module 320 may have three options: the proposed maximum frame rate 130 from the client device 104; a maximum allowed frame rate defined by server configuration or policy; and a measured current frame rate based on a current performance of the server (e.g., from game render time, encoder time, time slice for a virtual machine (VM) of the server, etc.). The frame rate control module 320 then may select the target frame rate 132 from these three options based on which option is best suited to provide a sustainable frame rate.

The gaming server 102 uses the determined target frame rate 132 to synchronize the operations of the gaming server 102 related to the rendering and capture of the video frames 116 to the target frame rate 132. Accordingly, in at least one implementation, at block 432 the target frame rate 132 is provided to the KMD 316-2, which in turn generates a frame rate synchronization (RSync) “signal” 136 that represents the target frame rate 132. Although illustrated as a periodic square wave in FIG. 1 for illustrative purposes, the RSync signal 136, in at least one implementation, is not a “signal” per se, but rather a representation of the synchronization between the KMD 316-2 and UMD 316-1 in selectively blocking (or delaying) the rendering of a next video frame through control of a synchronization object between the KMD 316-2 and the UMD 316-1. To illustrate, at the initiation of the video game instance 108, the UMD 316-1 and KMD 316-2 can perform a handshake procedure in which the UMD 316-1 signals that it is capable of supporting the RSync process described herein, and, in furtherance of this capability, the UMD 316-1 registers a synchronization object with the KMD 316-2 for use in implementing the RSync signal 136 during execution of the video game instance 108. Thereafter, and in response to determination of the target frame rate 132, the KMD 316-2 signals the synchronization object at a frequency corresponding to the target frame rate 132. The event of the KMD 316-2 signaling, or asserting, the synchronization object is referred to herein as a “kernel event” and, as described below, can serve as the basis for frame rate control. For example, the KMD 316-2 can assert the synchronization object (that is, trigger a “kernel event”) at a frequency equal to a frame frequency represented by the target frame rate 132 (e.g., every 16.667 milliseconds (ms) for a target frame rate of 60 FPS), and this sequence of kernel events involving the synchronization object between the KMD 316-2 and the UMD 316-1 serves as the RSync signal 136 for the frame rate control process described herein

In this example implementation, at block 434 the RSync signal 136 is used to control the rendering operations for the executing video game instance 108. To illustrate, in one implementation the KMD 316-2 issues a kernel event to the UMD 316-1 and, in response to the start of a new frame period as represented in the kernel event, the UMD 316-1 controls the executing video game instance 108 to render a corresponding video frame 116 for that frame period. As described in greater detail below with reference to FIG. 5, the process by which the UMD 316-1 controls the rendering behavior of the video game instance 108 can include the UMD 316-1 blocking the return of the present call of the video game instance 108 until a kernel event is unblocked by the KMD 316-2 based on the RSync signal 136, with this unblocking permitting the present call to proceed for the video game instance 108, resulting in a rendered video frame 112 (block 414 of subprocess 402). The server streaming application 318 then may encode the resulting video frame 116 to generate a corresponding encoded video frame 116, as described above with reference to block 416 of subprocess 402.

Thereafter, the client device 104 may send an updated proposed maximum frame rate 130 to reflect the maximum frame rate supportable by the client device 104 under changed circumstances (e.g., a change in allocated GPU bandwidth or a change in network latency), in response to which another iteration of the subprocess 406 is performed to determine an updated target frame rate 132, which in turn updates the periodicity/frequency of the RSync signal 136 accordingly. To illustrate, in at least one implementation, the frame rate control module 220 of the client streaming application 218 utilizes the input queue 224 of the decoder 222 to adjust the target frame rate 132. The input queue 224 filling up could indicate that the gaming server 102 is rendering video frames faster than the present rate of the client device 104. In some implementations, the decoder frequency (that is, the decoder job rate) is not regulate, and thus the decoder 222 typically injects decoded frames 120 into the display pipeline of the display 210 to present and relies on the display pipe to back pressure the decoder, which eventually manifests in the input queue 224 becoming full. Thus, in this approach, the frame rate control module 220 monitors the fullness of the input queue 224 and when the fullness exceeds a specified high threshold (which may be fixed or vary to reflect changes in other conditions), the frame rate control module 220 may send an updated proposed maximum frame rate 130 that reflects a lower maximum frame rate in order to instigate the gaming server 102 to lower the target frame rate 132 accordingly. Conversely, in some implementations, if the fullness of the input queue 224 falls below a lower threshold, indicating that the decoder 222 is decoding frames for presentation faster than the gaming server 102 is rendering frames, the frame rate control module 220 can send an updated proposed maximum frame rate that represents an increased maximum frame rate so as to instigate the gaming server 102 to increase the target frame rate 132 in response. Similarly, the frame rate control module 320 of the server streaming application 318 can modify the target frame rate 132 independently of client feedback, such as in response to a change in hardware resources allocated to the video game instance 108, in response to a change in network bandwidth as observed server-side, and the like.

In this approach, the client device 104 proposes a maximum frame rate (proposed max frame rate 130) that can be supported by the client device 104 under current circumstances, and the gaming server 102 uses this proposed maximum frame rate as the ceiling by which it sets its own rendering frame rate that can be supported by the gaming server 102 under its current circumstances, and then synchronizes the frame rendering process via the RSync signal 136. The result is the rendering of video frames 116 at a rate that should be encodable by the encoder 322 of the server streaming application 318 and the resulting encoded video frames 116 transmitted at a sustainable rate given the associated current circumstances of the gaming server 102. This server rendering and client decoding and display rate match thus facilitates avoidance of missed frames for encoding, as well as improved latency through better synchronization between user gaming input and presentation of the resulting video frame(s) at the client device 104.

In implementations that make use of application programming interfaces (APIs) to control frame rendering and/or capture, such as with Microsoft DirectX APIs, the video game instance 108 renders a video frame, makes a present call to the API, and then proceeds to the rendering of the next video frame. As such, holding, or blocking, the present call delays the start of the next video frame, and thus selective holding of the present call provides a mechanism for frame rate control. FIG. 5 illustrates an implementation of the frame rate control process of block 434 using by the RSync signal 136 and which leverages the issuance of present calls, and the holding or blocking of returns therefrom, to synchronize the rendering and capture of video frames. As noted above, initiation of the video game instance 108 can involve the UMD 316-1 registering a synchronization object with the KMD 316-2 for purposes of frame rate control (as represented by initialization block 502). Thereafter, the KMD 316-2 then signals this synchronization object (that is, triggers a kernel event) at a frequency representative of the current target frame rate 132. Thus, at block 504 the KMD 316-2 determines whether the current frame period, represented by RSync signal 136, has expired. If not, then at block 506 the KMD 316-2 blocks the next kernel event and maintains the block until the RSync signal 136 indicates the current frame period has expired, at which point the KMD 316-2 unblocks the next kernel event at block 508 and thus permits the kernel event to be signaled to the UMD 316-1 through the registered synchronization object.

In a parallel process, at block 510 the video game instance 108 issues a present call to the UMD 316-1 to trigger the presentation of a rendered video frame 120. However, rather than immediately initiating frame presentation in response in the form of a return from the present call, the UMD 316-1 instead at block 512 determines the current status of the kernel event at the KMD 316-2. In the event that the kernel event is not blocked at the KMD 316-2, then at block 514 the UMD 316-1 blocks on the present call (that is, blocks a return of the present call to the video game instance) and maintains the block on the return of the present call until the kernel event is no longer blocked at the KMD 316-2, at which point the UMD 316-1 unblocks the return of the present call at block 516, which in turn triggers the video game instance 108 to start rendering the next video frame 116 for the video game instance 108 at block 518.

One aspect of remote synchronization between the gaming server 102 and the client device 104 is the implementation of vertical synchronization (vsync). In conventional local render-and-display system, such as a gaming console rendering video frames for local display, vsync typically makes use of double or triple buffering and page flipping for frame pixel data to ensure that one video frame is displayed in its entirety before the next video frame is displayed, and thus avoiding screen tearing. Thus, in order to provide synchronization between the display intent of the video game instance 108 and the local presentation of the resulting rendered video content, in at least one implementation the current vsync status employed by the video game instance 108 is communicated from the gaming server 102 to the client device 104 as, for example, metadata that is part of the data stream 118, and which is received by the client streaming application 218, which in turn configures the display pipeline to activate vsync or deactivate vsync for the display pipeline of the client device 104, consistent with the vsync status of the video game instance 108. To this end, the UMD 316-1 may communicate the vsync status of the video game instance 108 to the KMD 316-2 (as well as the OS 314), which in turn supplies a representation of the vsync status to the server streaming application 318 for inclusion as metadata in the data stream 118. Moreover, in certain implementations, the vsync process results in the issuance of a flip call to direct the KMD 316-2 to flip between paged buffers. However, as the remote render-capture-transmit process of the gaming server 102 does not utilize buffer flipping, the KMD 316-2 can emulate a page flip so as to satisfy the flip call by reporting a flip complete in response to receiving the flip call.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method performed at a server, comprising:
determining a target frame rate based on a first proposed maximum frame rate received from a client device and further based on one or more current parameters of the server;
rendering video frames of a stream of video frames based on the target frame rate;
encoding video frames of the stream to generate a stream of encoded video frames; and
transmitting the stream of encoded video frames to the client device via at least one network.

2. The method of claim 1, further comprising:
modifying the target frame rate based on a second proposed maximum frame rate received from the client device after receiving the first proposed maximum frame rate; and
rendering video frames of the stream of video frames based on the modified target frame rate.

3. The method of claim 1, further comprising:
modifying the target frame rate based on one or more updated current parameters of the server; and
rendering the stream of video frames based on the modified target frame rate.

4. The method of claim 1, wherein the one or more current parameters of the server include at least one of: a network latency between the server and the client device; a network bandwidth between the server and the client device; a capacity of hardware resources of the server allocated to the client device; or a policy on frame rate set by an operator of the server.

5. The method of claim 1, wherein the target frame rate is determined from the first proposed maximum frame rate and the one or more current parameters using at least one of: a weighted sum equation; an algorithm; a look-up table; or a trained neural network.

6. The method of claim 1, wherein the stream of video frames is generated for an instance of a video game application executing at the server on behalf of the client device.

7. The method of claim 6, further comprising:
determining a status of a vertical synchronization (vsync) feature of the instance of the video game application; and
transmitting a representation of the status of the vsync feature to the client device via the at least one network.

8. The method of claim 1, wherein rendering video frames of the stream of video frames based on the target frame rate comprises:
blocking a kernel event at a kernel mode driver until a start of a next frame period based on the target frame rate; and
receiving a present call at a user mode driver and blocking a return of the present call at the user mode driver until the kernel event is unblocked, wherein when the return of the present call is unblocked the server initiates rendering of a video frame of the stream.

9. A server comprising:
a network interface coupleable to at least one network;
at least one processor coupled to the network interface; and
at least one memory coupled to the at least one processor, the at least one memory storing executable instructions to manipulate the at least one processor to:
determine a target frame rate based on a first proposed maximum frame rate received from a client device via the at least one network and based on one or more current parameters of the server;
render video frames of a stream of video frames based on the target frame rate;
encode video frames of the stream to generate a stream of encoded video frames; and
provide the stream of encoded video frames to the network interface for transmission to the client device via at least one network.

10. The server of claim 9, wherein the executable instructions further are to manipulate the at least one processor to:
modify the target frame rate based on a second proposed maximum frame rate received from the client device after receiving the first proposed maximum frame rate; and
render video frames of the stream of video frames based on the modified target frame rate.

11. The server of claim 9, wherein the executable instructions further are to manipulate the at least one processor to:
modify the target frame rate based on one or more updated current parameters of the server; and
render the stream of video frames based on the modified target frame rate.

12. The server of claim 9, wherein the one or more current parameters of the server include at least one of: a network latency between the server and the client device; a network bandwidth between the server and the client device; a capacity of hardware resources of the server allocated to the client device; or a policy on frame rate set by an operator of the server.

13. The server of claim 9, wherein the target frame rate is determined from the first proposed maximum frame rate and the one or more current parameters using at least one of: a weighted sum equation; an algorithm; a look-up table; or a trained neural network.

14. The server of claim 9, wherein the at least one processor generates the stream of video frames for an instance of a video game application executing at the server on behalf of the client device.

15. The server of claim 9, wherein the executable instructions configured to manipulate the at least one processor to render video frames of the stream of video frames based on the target frame rate comprise executable instructions configured to manipulate the at least one processor to:
block a kernel event at a kernel mode driver until a start of a next frame period based on the target frame rate; and
receive a present call at a user mode driver and block a return of the present call at the user mode driver until the kernel event is unblocked, wherein when the return of the present call is unblocked the server initiates rendering of a video frame of the stream.

16. A method performed at a client device, comprising:
determining a first proposed maximum frame rate based on one or more current parameters of the client device;
transmitting the first proposed maximum frame rate to a server via at least one network;
receiving, from the server via the at least one network, a first stream of encoded video frames that have been rendered at a first target frame rate that is based on the first proposed maximum frame rate;
decoding the first stream of encoded video frames to generate a first stream of decoded video frames; and
presenting the first stream of decoded video frames for display at a display associated with the client device.

17. The method of claim 16, further comprising:
determining a second proposed maximum frame rate based on one or more updated current parameters of the client device;
transmitting the second proposed maximum frame rate to the server via at least one network;
receiving, from the server via the at least one network, a second stream of encoded video frames that have been rendered at a second target frame rate that is based on the second proposed maximum frame rate;
decoding the second stream of encoded video frames to generate a second stream of decoded video frames; and
presenting the second stream of decoded video frames for display at the display.

18. The method of claim 17, wherein:
the one or more updated current parameters of the client device include an indication that an input queue of a decoder of the client device for decoding encoded video frames has risen above a fullness threshold;
the second proposed maximum frame rate is less than the first proposed maximum frame rate; and
the second target frame rate is less than the first target frame rate.

19. The method of claim 16, wherein the one or more current parameters of the client device include at least one of: a maximum display frame rate of the display; a network latency between the client device and the server; a network bandwidth between the client device and the server; or a hardware capacity of the client device for decoding and display of video frames.

20. The method of claim 16, wherein the first stream of encoded video frames is generated for an instance of a video game application executing at the server on behalf of the client device.

21. A client device comprising:
a network interface coupleable to at least one network;
at least one processor coupled to the network interface; and
at least one memory coupled to the at least one processor, the at least one memory storing executable instructions to manipulate the at least one processor to:
determine a first proposed maximum frame rate based on one or more current parameters of the client device;
transmit the first proposed maximum frame rate to a server via at least one network;
receive, from the server via the at least one network, a first stream of encoded video frames that have been rendered at a first target frame rate that is based on the first proposed maximum frame rate;
decode the first stream of encoded video frames to generate a first stream of decoded video frames; and
present the first stream of decoded video frames for display at a display associated with the client device.

22. The client device of claim 21, wherein the executable instructions further are to manipulate the at least one processor to:
determine a second proposed maximum frame rate based on one or more updated current parameters of the client device;
transmit the second proposed maximum frame rate to the server via at least one network;
receive, from the server via the at least one network, a second stream of encoded video frames that have been rendered at a second target frame rate that is based on the second proposed maximum frame rate;
decode the second stream of encoded video frames to generate a second stream of decoded video frames; and
present the second stream of decoded video frames for display at the display.

23. The client device of claim 22, wherein the one or more current parameters of the client device include at least one of: a maximum display frame rate of the display; a network latency between the client device and the server; a network bandwidth between the client device and the server; or a hardware capacity of the client device for decoding and display of video frames.

24. The client device of claim 21, wherein the first stream of encoded video frames is generated for an instance of a video game application executing at the server on behalf of the client device.
